(19) United States
(12) Patent Application Publication
(10) Pub. No.: US 2012/0015684 A1
(43) Pub. Date: Jan. 19, 2012

(54) ANTENNA CONTROLLER DEVICE, RADIO COMMUNICATION SYSTEM, AND ANTENNA CONTROLLING METHOD

(75) Inventor: Masaki Noji, Kanagawa (JP)

(73) Assignee: KYOCERA CORPORATION, Kyoto (JP)

(21) Appl. No.: 13/260,148

(22) PCT Filed: Mar. 25, 2010
(86) PCT No.: PCT/JP2010/055286

§ 371 Date: Sep. 23, 2011

(30) Foreign Application Priority Data
Mar. 26, 2009 (JP) 2009-077747

(51) Int. Cl. H04W 16/28; H01Q 3/02

(52) U.S. Cl. 455/524; 342/368

(57) ABSTRACT

A radio base station (100A) has a directional antenna (110A) by which the beam direction (D1) which is a direction to which a directional beam is directed can be changed in a vertical plane. The radio base station (100A) acquires a terminal altitude value indicating the altitude of a radio terminal connected to the radio base station (100A), and sets a tilt angle (θ) which is an angle made by the beam direction (D1) and the horizontal direction by use of the acquired terminal altitude value.

### TECHNICAL FIELD

The present invention relates to an antenna controller device, a radio communication system, and an antenna controlling method for controlling an antenna unit capable of changing a beam direction in a vertical plane, the beam direction being a direction to which a directional beam is directed.

### BACKGROUND ART

Conventionally, cellular radio communication systems (hereinafter, cellular system) has achieves an area-wide coverage of a wide service area by dividing the wide service area into units of communication areas called cells and by equipping the communication areas with radio base stations in charge of radio communications with radio terminals in their respective communication areas.

In order to expand the communication area of a radio base station, it is effective to install an antenna unit of the radio base station (hereinafter a base station antenna) at a high position. For this reason, in the conventional cellular system, the base station antennas are generally installed at high-altitude positions such as roofs of buildings and tops of steel towers.

In a place where the communication areas overlap each other, communication quality is deteriorated due to an influence of interference. Accordingly, there is used a beam tilt technique which employs a directional antenna having vertical directivity as the base station antenna and directs a directional beam formed by the base station antenna at an angle on a depression side (downward from the horizontal direction) depending on an amount of interfering with an adjacent communication area and the like.

By setting a tilt angle of the base station antenna (an angle formed between a beam direction and the horizontal direction) to an appropriate angle on the depression side, it is possible to optimize the radius of the communication area and the electric field intensity in the communication area, whereby communication quality in each of the communication areas can be improved (see Patent Document 1, for example).

### PRIOR ART DOCUMENT

### Patent Document

Patent Document 1: Japanese Patent No. 4106570

### SUMMARY OF INVENTION

With a focus on speeding-up of a communication rate, next-generation radio communication systems such as WiMAX and LTE (Long Term Evolution) under standardization in recent years employ a method in which the density of installed radio base stations is increased while the communication area covered by each of the base stations is reduced (so-called micro-cell formation).

For the micro-cell formation, the base station antennas are supposed to be installed not only at high-altitude positions as in the conventional case but also at low-altitude positions such as telephone poles and other poles between buildings, and walls of buildings. Such an installation leads to a situation where the radio terminals are spread over in the height direction (vertical direction) around a base station antenna, and where the altitudes of some radio terminals are higher than the altitude of a base station antenna.

However, the conventional beam tilt technique adjusts the tilt angle only within an angle range on the depression side by using the amount of interfering and the like based on the design of area-wide communication area, and therefore has a problem of being incapable of offering a high quality communication service to the radio terminals spread over in the height direction.

Accordingly, it is an object of the present invention to provide an antenna controller device, a radio communication system, and an antenna controlling method which are capable of appropriately setting a tilt angle and offering a high quality communication service to radio terminals even when a base station antenna is installed at a low-altitude position and the radio terminals are spread over in a height direction.

The present invention has the following characteristics to solve the problems described above. First of all, a first characteristic of the present invention is summarized as an antenna controller device (controller 130A or base station controller 300) configured to control an antenna unit (directional antenna 110A or multiple antennas) capable of changing a beam direction (beam direction D1) in a vertical plane, the beam direction being a direction to which a directional beam is directed, the antenna controller device comprising: an acquisition unit (acquisition unit 131A or acquisition unit 331) configured to acquire a terminal altitude value indicating an altitude of a radio terminal (radio terminal 200) connected to a radio base station (radio base station 100A) including the antenna unit; and a setting unit (setting unit 132A or setting unit 332) configured to set a tilt angle (tilt angle θ) being an angle formed between the beam direction and a horizontal direction (horizontal direction D2), by use of the terminal altitude value acquired by the acquisition unit.

The above-described antenna controller device sets the tilt angle by use of the terminal altitude value indicating the altitude of the radio terminal. Hence the tilt angle is adapted to the altitude of the radio terminal in consideration of the altitude of the radio terminal. Therefore, even when the base station antenna is installed at a low-altitude position while the radio terminals are spread over in the height direction, it is possible to set the tilt angle appropriately and to offer a high quality communication service to the radio terminals.

A second characteristic of the present invention is summarized in that, in the first characteristic of the present invention, the setting unit sets the tilt angle to an angle of an elevation side.

A third characteristic of the present invention is summarized in that, in the first characteristic of the present invention, when a plurality of radio terminals spread over in a height direction are connected to the radio base station, the acquisition unit acquires the terminal altitude value for each of the plurality of radio terminals, and the setting unit sets the tilt angle based on a state of distribution of the terminal altitude values acquired respectively for the plurality of radio terminals.

A fourth characteristic of the present invention is summarized in that, in the third characteristic of the present invention, the setting unit sets a beam width of the directional beam based on the state of distribution in addition to setting the tilt angle.

A fifth characteristic of the present invention is summarized in that, in the first characteristic of the present invention, the acquisition unit further acquires a base station altitude value (base station altitude value β) indicating an altitude of either the antenna unit or the radio base station, and the setting unit sets the tilt angle by further using the base station altitude value acquired by the acquisition unit.

A sixth characteristic of the present invention is summarized in that, in the fifth characteristic of the present invention, when the terminal altitude value is greater than the base station altitude value, the setting unit sets the tilt angle to a larger angle on the elevation side as a difference between the terminal altitude value and the base station altitude value becomes greater.

A seventh characteristic of the present invention is summarized in that, in the first characteristic of the present invention, the acquisition unit further acquires information on a different antenna unit (directional antenna 110B) at an installation position different from the antenna unit, and the setting unit sets the tilt angle by further using the information on the different antenna unit so that the directional beam of the antenna unit and the directional beam of the different antenna unit do not overlap each other.

An eighth characteristic of the present invention is summarized in that, in the first characteristic of the present invention, the acquisition unit further acquires a horizontal distance value (horizontal distance value d) indicating a horizontal distance between either the antenna unit or the radio base station and the radio terminal, and the setting unit sets the tilt angle by further using the horizontal distance value acquired by the acquisition unit.

A ninth characteristic of the present invention is summarized in that, in the first characteristic of the present invention, when the radio base station receives positioning data indicating a result of position measurement by the radio terminal from the radio terminal, the acquisition unit acquires the terminal altitude value based on the positioning data received by the radio base station.

A tenth characteristic of the present invention is summarized as a radio communication system supporting LTE and comprising a first radio base station having a first antenna unit and a second radio base station having a second antenna unit, wherein the first radio base station comprises a transmitter configured to transmit tilt angle information indicating a tilt angle of the first antenna unit to the second radio base station through an X2 interface, and the second radio base station comprises a receiver configured to receive the tilt angle information through the X2 interface.

An eleventh characteristic of the present invention is summarized as a radio communication system supporting LTE and comprising a first radio base station having a first antenna unit and a second radio base station having a second antenna unit, wherein the first radio base station comprises a transmitter configured to transmit installation position information indicating an installation position of the first antenna unit to the second radio base station through an X2 interface, and the second radio base station comprises a receiver configured to receive the installation position information through the X2 interface.

A twelfth characteristic of the present invention is summarized as an antenna control method of controlling an antenna unit capable of changing a beam direction in a vertical plane, the beam direction being a direction to which a directional beam is directed, the antenna control method comprising the steps of: acquiring (step S102) a terminal altitude value indicating an altitude of a radio terminal connected to a radio base station including the directional antenna; and setting (steps S103 to S105) a tilt angle being an angle formed between the beam direction and a horizontal direction by use of the terminal altitude value acquired in the acquiring step.

According to the present invention, there are provided an antenna controller device, a radio communication system, and an antenna controlling method which are capable of appropriately setting a tilt angle and offering a high quality communication service to radio terminals even when a base station antenna is installed in a low-altitude position and the radio terminals are spread over in a height direction.

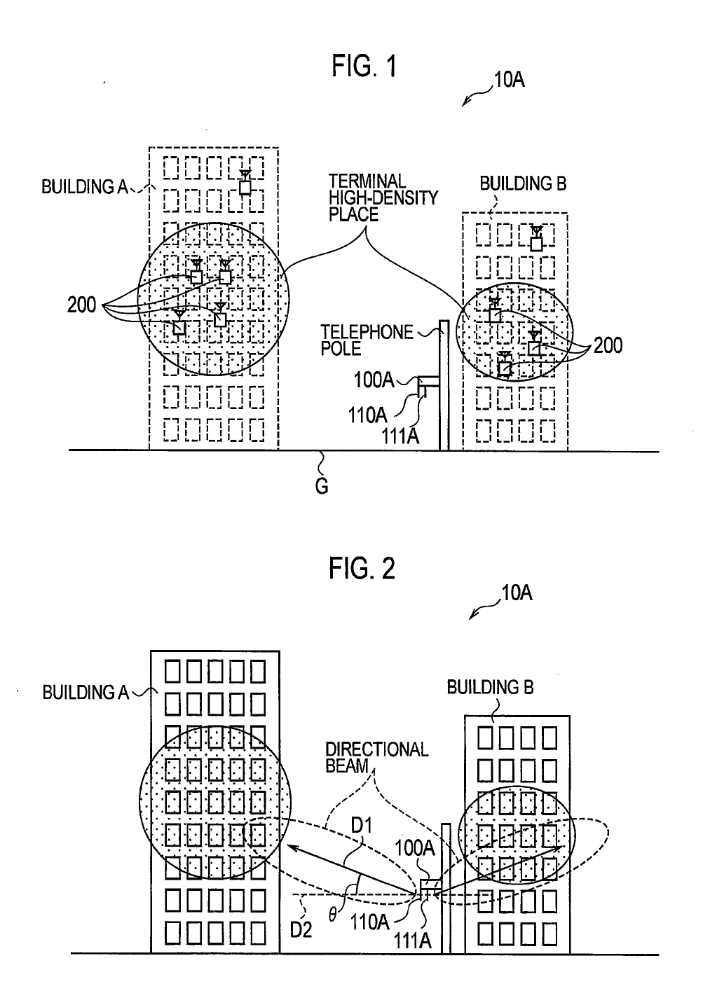

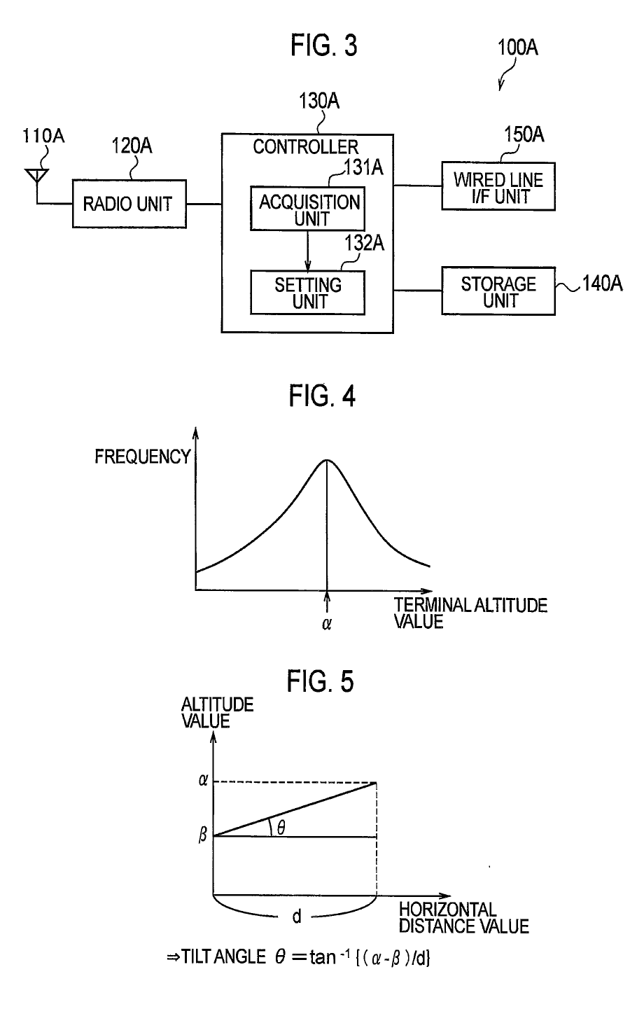

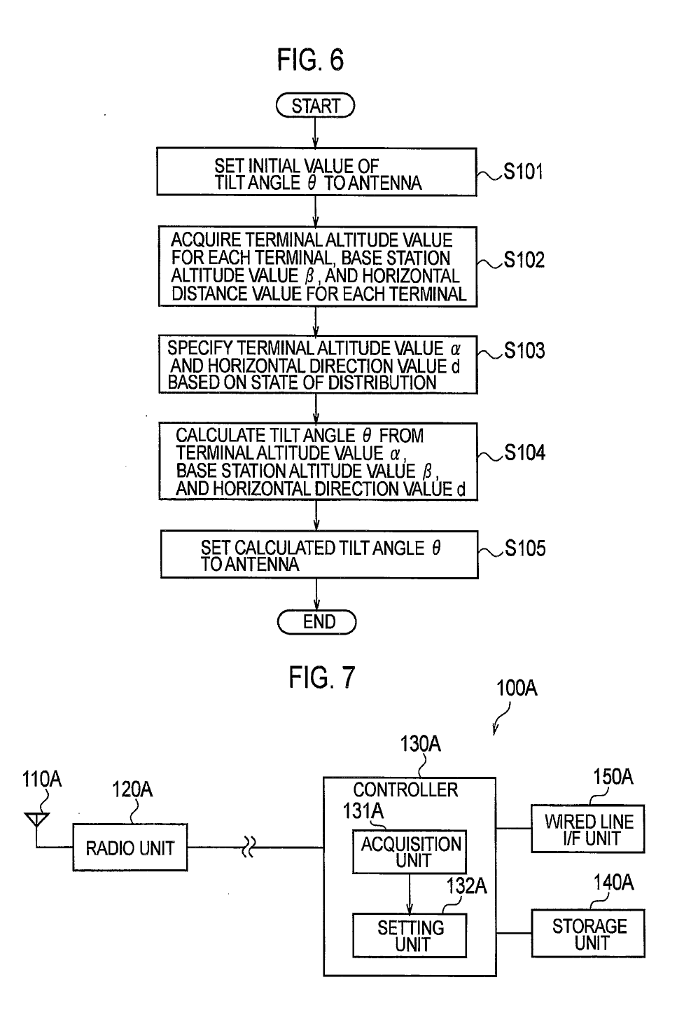

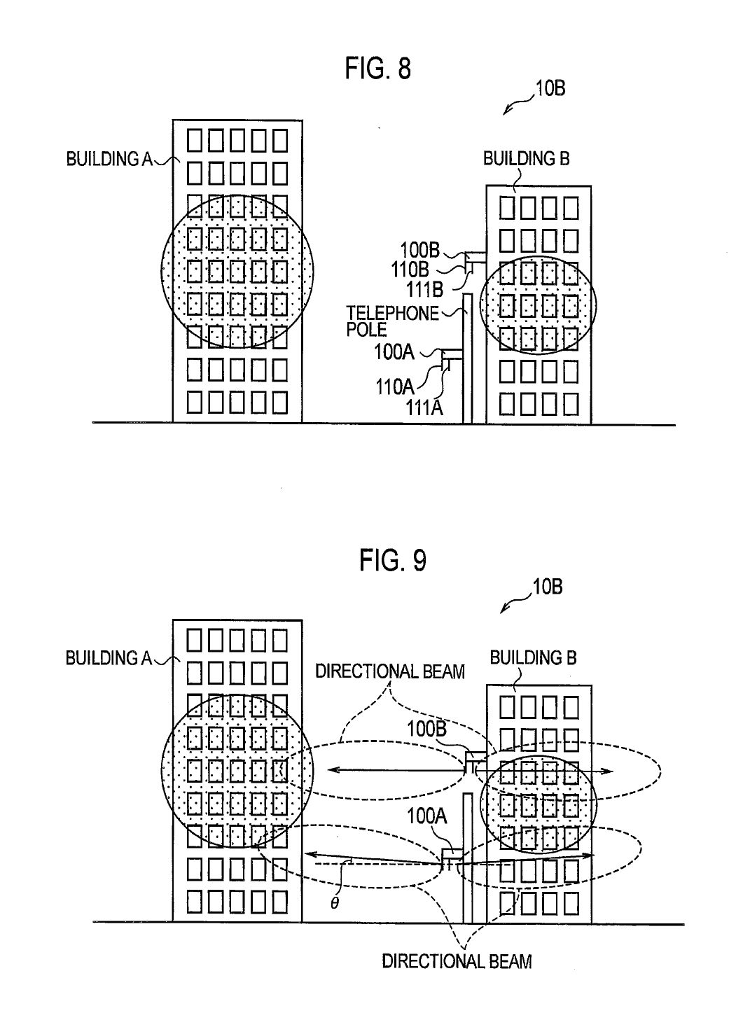

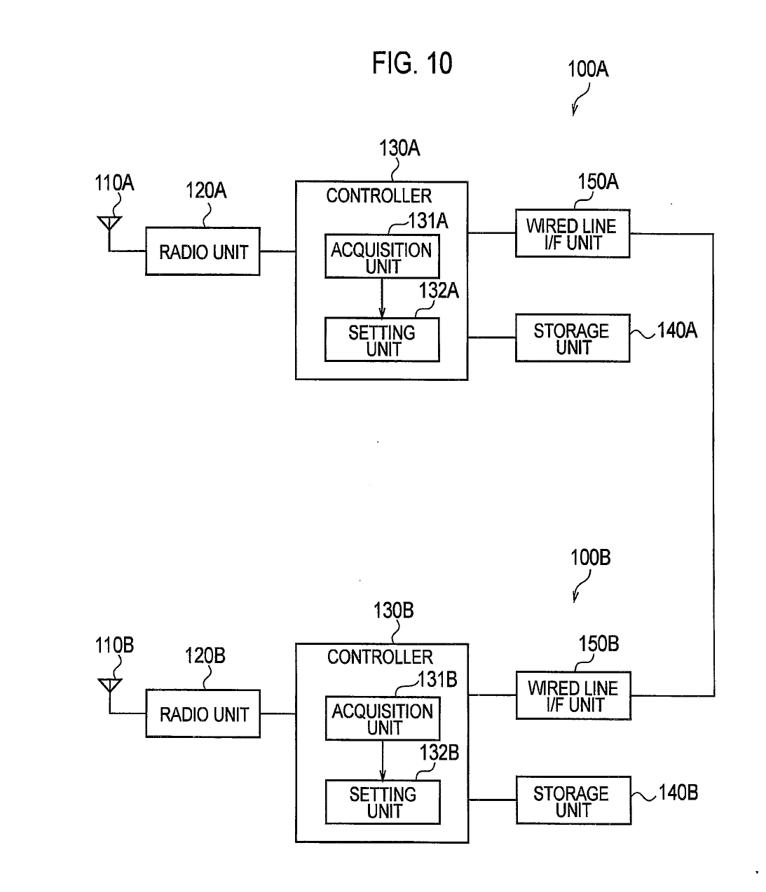

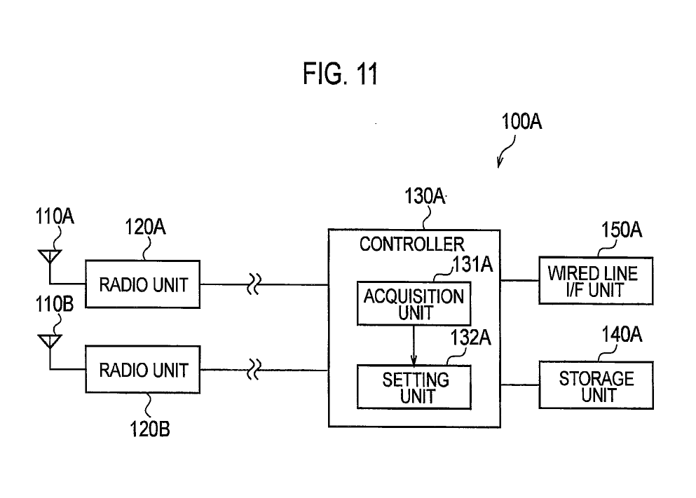

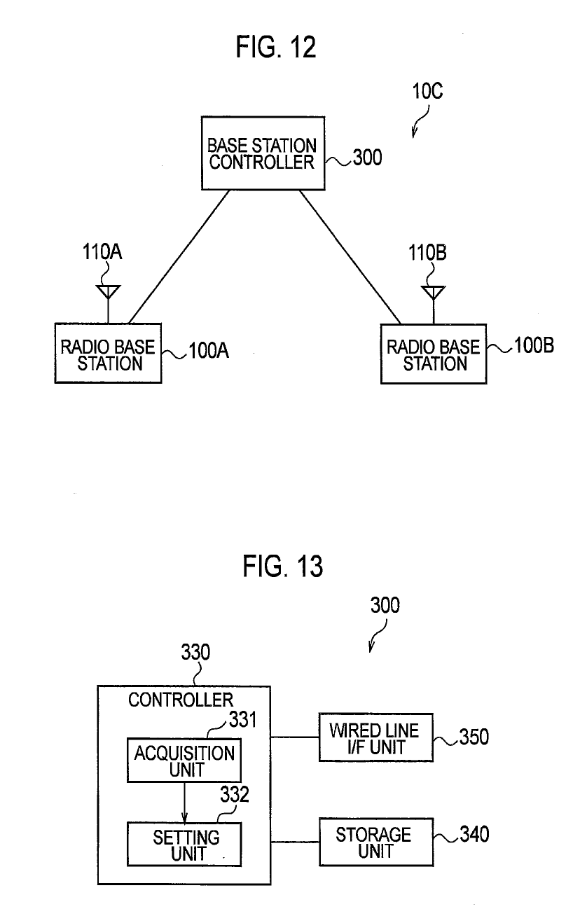

### BRIEF DESCRIPTION OF DRAWINGS

[FIG. 1] FIG. 1 is a schematic configuration diagram of a radio communication system according to a first embodiment of the present invention.

[FIG. 2] FIG. 2 is a diagram showing an outline of an antenna controlling method according to the first embodiment of the present invention.

[FIG. 3] FIG. 3 is a block diagram showing a configuration of a radio base station according to the first embodiment of the present invention.

[FIG. 4] FIG. 4 is a (first) diagram for showing a method of setting a tilt angle according to the first embodiment of the present invention.

[FIG. 5] FIG. 5 is a (second) diagram for showing the method of setting a tilt angle according to the first embodiment of the present invention.

[FIG. 6] FIG. 6 is a flowchart showing operations of a control unit (an antenna controller device) of the radio base station according to the first embodiment of the present invention.

[FIG. 7] FIG. 7 is a block diagram showing a configuration of a radio base station according to a modification of the first embodiment of the present invention.

[FIG. 8] FIG. 8 is a schematic configuration diagram of a radio communication system according to a second embodiment of the present invention.

[FIG. 9] FIG. 9 is a diagram showing an outline of an antenna controlling method according to the second embodiment of the present invention.

[FIG. 10] FIG. 10 is a block diagram showing a configuration of a radio base station according to a second embodiment of the present invention.

[FIG. 11] FIG. 11 is a block diagram showing a configuration of a radio base station according to a modification of the second embodiment of the present invention.

[FIG. 12] FIG. 12 is a schematic configuration diagram of a radio communication system according to a third embodiment of the present invention.

[FIG. 13] FIG. 13 is a block diagram showing a configuration of a base station controller (an antenna controller device) according to the third embodiment of the present invention.

### DESCRIPTION OF EMBODIMENTS

Next, a first embodiment, a second embodiment, a third embodiment, and other embodiments of the present invention will be described with reference to the accompanying drawings. In the following description of the drawings, same or similar reference signs denote same or similar elements and portions.

### First Embodiment

In a first embodiment, (1) Outline of Radio Communication System, (2) Configuration of Radio Base Station, (3) Operation of Radio Base Station, and (4) Operation and Effect will be described.

### (1) Outline of Radio Communication System

FIG. 1 is a schematic configuration diagram of a radio communication system 10A according to the first embodiment. The radio communication system 10A has a configuration based on a next-generation radio communication system such as the WiMAX or the LTE.

As shown in FIG. 1, the radio communication system 10A includes multiple ratio terminals 200 and a radio base station 100A.

The radio terminals 200 are spread over in buildings, i.e., a building A and a building B, and connected to the radio base station 100A. That is, the radio terminals 200 perform stand-by or data transmission and reception with the radio base station 100A.

Each of the radio terminals 200 includes a position measurement unit such as a GPS (Global Positioning System) and measures the own position (a longitude, a latitude, and an altitude) by using the position measurement unit. Each of the radio terminals 200 periodically transmits positioning data indicating a result of position measurement to the radio base station 100A. Here, the positioning data may be data indicating only the altitude of the radio terminal 200.

In the radio communication system 10A, the ratio base stations 100A are also installed at low-altitude positions including telephone poles and other poles located between buildings, walls of buildings, and the like in order to achieve micro-cell formation. In the example in FIG. 1, the radio base station 100A is installed on a telephone pole located between (in a canyon of) the building A and the building B.

The radio base station 100A includes a directional antenna 110A and a directional antenna 111A (an antenna unit). Each of the directional antenna 110A and the directional antenna 111A is an antenna which can change abeam direction being a direction to direct a directional beam in a vertical plane. Here, “directivity” includes two directional factors of transmission directivity and reception directivity.

The directional antenna 110A is used for radio communications with the radio terminals 200 located in the building A. The directional antenna 111A is used for radio communications with the radio terminals 200 located in the building B. In the first embodiment, the directional antenna 110A and the directional antenna 111A are provided integrally with a body of the radio base station 100A.

The directional antenna 110A and the directional antenna 111A are antennas which can change tilt angles electrically, for example. As for specifications of the directional antenna 110A and the directional antenna 111A, it is possible to use an established standard such as AISG.

When the radio base station 100A is installed as shown in FIG. 1, the radio terminals 200 are spread over in a height direction (a vertical direction) around the directional antenna 110A and the directional antenna 111A. Specifically, many of the radio terminals 200 exist at positions with higher altitude than the altitudes of the directional antenna 110A and the directional antenna 111A.

In the example of FIG. 1, the terminals 200 exist densely in positions higher than a ground surface G, or more specifically, in positions at or above middle floors of the buildings A and B. In the following, a place where the radio terminals 200 densely exist will be referred to as a “terminal high-density place”.

FIG. 2 is a diagram showing an outline of an antenna controlling method according to the first embodiment

As shown in FIG. 2, the radio base station 100A sets a tilt angle θ of the directional antenna 110A to an angle on an elevation side (upward from the horizontal direction) so as to direct a directional beam of the directional antenna 110A to the terminal high-density place in the building A. Here, the tilt angle θ is defined as an angle formed between a beam direction D1 and a horizontal direction D2.

The radio base station 100A sets the tilt angle θ of the directional antenna 110A by use of a terminal altitude value indicating an altitude of a radio terminal 200 existing in the building A. In this way, the tilt angle θ of the directional antenna 110A is adapted to the altitude of the radio terminal 200 in consideration of the altitude of the radio terminal 200 existing in the building A.

Similarly, the radio base station 100A sets a tilt angle of the directional antenna 111A to an angle on the elevation side as shown in FIG. 2 so as to direct a directional beam of the directional antenna 111A to the terminal high-density place in the building B.

The radio base station 100A sets the tilt angle θ of the directional antenna 111A by use of a terminal altitude value indicating an altitude of a radio terminal 200 existing in the building B. In this way, the tilt angle θ of the directional antenna 111A is adapted to the altitude of the radio terminal 200 in consideration of the altitude of the radio terminal 200 existing in the building B.

### (2) Configuration of Radio Base Station

FIG. 3 is a block diagram showing a configuration of the radio base station 100A according to the first embodiment. Here, a similar controlling method is applied to the directional antenna 110A and the directional antenna 111A. Accordingly, the first embodiment will be described below with description of the directional antenna 111A omitted.

As shown in FIG. 3, the radio base station 100A includes the directional antenna 110A, a radio unit 120A, a controller 130A, a storage unit 140A, and a wired line I/F unit 150A.

The directional antenna 110A is an antenna which can change the tilt angle θ to any angle on the elevation side either electrically or mechanically. When the angle on the elevation side is defined as positive, for example, the directional antenna 110A can change the tilt angle θ within a range from 0° (the horizontal direction) to +90°.

The radio unit 120A transmits and receives radio signals through the directional antenna 110A. The radio unit 120A includes a transmitter provided with an up-converter, a power amplifier and the like, and a receiver provided with a down-converter, a low noise amplifier and the like.

The controller 130A is formed of a CPU, for example, and is configured to control various functions of the radio base station 100A. The storage unit 140A is formed of a memory, for example, and is configured to store various information pieces used for control in the control unit 130A. In the first embodiment, the controller 130A and the storage unit 140A collectively constitute an antenna controller device configured to control the directional antenna 110A. The wired line I/F unit 150A is connected to an upper network apparatus (such as a server or a gateway) through a wired line.

The control unit 130A includes an acquisition unit 131A and a setting unit 132A. The acquisition unit 131A acquires the terminal altitude value indicating the altitude of the radio terminal 200 based on the positioning data (GPS data) received through the directional antenna 110A and the radio unit 120A. The acquisition unit 131A acquires the terminal altitude value for each of the radio terminals 200. The terminal altitude values acquired by the acquisition unit 131A are accumulated in the storage unit 140A.

The acquisition unit 131A further acquires a base station altitude value β (see FIG. 6) indicating an altitude of the directional antenna 110A. Since the directional antenna 110A and the radio base station 100A are integrally provided in the first embodiment, the base station altitude value β may be a value indicating an altitude of the radio unit 120A or the controller 130A, for example.

The base station altitude value β is stored in the storage unit 140A in advance and the acquisition unit 131A acquires the base station altitude value β from the storage unit 140A. When the radio base station 100A is provided with a position measurement unit such as a GPS, the acquisition unit 131A may acquire the base station altitude value β based on positioning data from the position measurement unit.

The acquisition unit 131A further acquires a horizontal distance value indicating a distance in the horizontal direction between the directional antenna 110A (or the radio base station 100A) and the radio terminal 200. The acquisition unit 131A acquires the horizontal distance value for each of the radio terminals 200.

For example, the acquisition unit 131A acquires the horizontal distance based on the positioning data (the longitude and the latitude) from the radio terminal 200 and on a longitude and a latitude of the directional antenna 110A (or the radio base station 100A). Alternatively, the acquisition unit 131A may acquire the horizontal distance value by use of a value of a propagation loss based on electric field intensity. The horizontal direction values acquired by the acquisition unit 131A are accumulated in the storage unit 140A.

As shown in FIG. 4, the setting unit 132A performs statistical processing on the terminal altitude values accumulated in the storage unit 140A and specifies the altitude value indicating the densest distribution of the radio terminals 200 as a “terminal altitude value α”. Note that FIG. 4 shows accumulated density distribution of the terminal altitude values for each of the radio terminals.

For example, the setting unit 132A specifies a representative value (an average value, a median value or a mode value) of the terminal altitude values accumulated in the storage unit 140A as the terminal altitude value α.

Similarly, the setting unit 132A performs statistical processing on the horizontal distance values accumulated in the storage unit 140A and specifies the horizontal distance value indicating the densest distribution of the radio terminals 200 as a “horizontal distance value d”. For example, the setting unit 132A specifies a representative value (an average value, a median value or a mode value) of the horizontal distance values accumulated in the storage unit 140A as the horizontal distance value d.

As shown in FIG. 5, the setting unit 132A sets the tilt angle θ based on the terminal altitude value α, the base station altitude value β, and the horizontal distance value d. Specifically, the setting unit 132 sets the tilt angle θ based on the following formula:

θ=tan⁻¹{(α−β)/d} (1)

### (3) Operation of Radio Base Station

FIG. 6 is a flowchart showing operations the radio base station 100A according to the first embodiment.

In Step S101, the setting unit 132A sets an initial value of the tilt angle θ stored in storage unit 140 in advance to the directional antenna 110A. The radio base station 100A (the directional antenna 110A) is operated by use of the initial value at an initial state of installation.

After starting the operation, in Step S102, the acquisition unit 131A acquires the terminal altitude value of each of the radio terminals 200 and the horizontal distance value of each of the radio terminals 200 based on the positioning data (the GPS data) received from each of the radio terminals 200 existing in the neighborhood. The terminal altitude values and the horizontal distance values thus acquired are accumulated in the storage unit 140A. Meanwhile, the acquisition unit 131A acquires the base station altitude value β.

In Step S103, the setting unit 132A specifies the value representing the highest distribution density among the terminal altitude values accumulated in the storage unit 140A as the terminal altitude value α, and specifies the value representing the highest distribution density among the horizontal distance values accumulated in the storage unit 140A as the horizontal distance value d.

In Step S104, the setting unit 132A calculates the tilt angle θ in accordance with the formula (1) by using the terminal altitude value α specified in Step S103, the horizontal distance value d specified in Step S103, and the base station altitude value β acquired in Step S102.

In Step S105, the setting unit 132A sets the tilt angle θ calculated in Step S104 to the directional antenna 110A. The directional antenna 110A changes the beam direction D1 in the vertical plane in accordance with the set tilt angle θ.

Here, the processing from Step S102 to Step S105 is repeatedly executed at a given time interval. The tilt angle θ is controlled so as to follow the state of distribution of the radio terminals 200 by continuously updating the tilt angle θ set to the directional antenna 110A.

### (4) Operation and Effect

The setting unit 132A of the controller 130A (the antenna controller device) according to the first embodiment sets the tilt angle θ by using the terminal altitude value indicating the altitude of the radio terminal 200. For this reason, it is possible to automatically adapt the tilt angle θ to the altitude of the radio terminal 200 in consideration of the altitude of the radio terminal 200, and thereby to construct a three-dimensional communication area.

Therefore, even if the directional antenna 110A is installed at a low-altitude position and the radio terminals 200 are spread over in the vertical direction, it is possible to set the tilt angle θ appropriately and thereby to offer a high quality communication to the radio terminals 200.

The setting unit 132A of the controller 130A (the antenna controller device) sets the tilt angle θ based on the state of distribution of the terminal altitude values acquired for each of the radio terminals 200. In this way, even in an environment where a majority of the radio terminals 200 exist in higher positions than the directional antenna 110A, it is possible to adapt the tilt angle θ automatically to the altitude value representing the highest distribution density of the radio terminals 200, and thereby to offer the high quality communication service to the majority of the radio terminals 200.

### (Modification of First Embodiment)

FIG. 7 is a block diagram showing a configuration of the radio base station 100A according to a modification of the first embodiment

The directional antenna 110A is provided integrally with the body of the radio base station 100A in the first embodiment whereas the directional antenna 110A is provided separately from the body of the radio base station 100A in this modification. For example, the radio unit 120A and the control unit 130A of the radio base station 100A is connected to each other via an optical fiber line or the like. As for the above-described interface, it is possible to use an established standard such as CPRI (Common Public Radio Interface).

In the installation example as shown in FIG. 1, there may be a case where it is difficult to install the entire radio base station 100A on the telephone pole. In such a case, it is conceivable to install a radio instrument (RE) provided with the directional antenna 110A and the radio unit 120A on the telephone pole and to install a radio control instrument (REC) provided with the storage unit 140A and the wired line I/F unit 150A on the ground or the like.

When a split configuration is employed as in the modification, it is preferable to use an altitude value of either the directional antenna 110A or the radio unit 120A as the above-described base station altitude value β.

### Second Embodiment

In a second embodiment, (1) Outline of Radio Communication System, (2) Configuration of Radio Base Station, and (3) Operation and Effect will be described. Only different features from those of the first embodiment will be described and duplicate explanation will be omitted.

### (1) Outline of Radio Communication System

FIG. 8 is a schematic configuration diagram of a radio communication system 10B according to the second embodiment. As shown in FIG. 8, the radio communication system 10B is different from the first embodiment in that the radio base station 100A and a radio base station 100B are installed separately in the height direction. In the example of FIG. 8, the radio base station 100B is installed above the radio base station 100A and on a wall face of the building B.

The radio base station 100B includes a directional antenna 110B and a directional antenna 111B. The directional antenna 110B is used for radio communications with the radio terminals 200 existing in the building A. The directional antenna 111B is used for radio communications with the radio terminals 200 existing in the building B. Note that the configuration of the radio base station 100A is similar to that in the first embodiment.

In the condition of installation as shown in FIG. 8, if each of the radio base station 100A and the radio base station 100B independently sets the tilt angle, there is a risk of causing interference by radio waves from both base stations. As shown in FIG. 9, the radio base station 100A and the radio base station 100B set the tilt angles based on a positional relationship between the radio base station 100A and the radio base station 100B and on values of the respective tilt angles set by the radio base station 100A and the radio base station 100B so as not to cause directional beams to overlap each other.

### (2) Configuration of Radio Base Station

FIG. 10 is a block diagram showing configurations of the radio base station 100A and the radio base station 100B according to the second embodiment. Here, a controlling method is applied to the directional antenna 111A and the directional antenna 111B similar to that for the directional antenna 110A and the directional antenna 110B. Accordingly, the second embodiment will be described below with the description of the directional antenna 111A and the directional antenna 111B omitted.

Each of the radio base station 100A and the radio base station 100B has the configuration similar to that in the first embodiment. However, this embodiment is different from the first embodiment in that the wired line I/F unit 150A of the radio base station 100A and a wired line I/F unit 150B of the radio base station 100B are connected to each other through a wired line. For this wired line, it is possible to use an interface such as an X2 interface which is standardized in the LTE.

The acquisition unit 131A of the radio base station 100A acquires tilt angle information indicating the tilt angle of the directional antenna 110B installed in the different position from that of the directional antenna 110A and installation position information indicating an installation position of the directional antenna 110B from the radio base station 100B via the wired line I/F unit 150A. The setting unit 132A of the radio base station 100A sets the tilt angle θ of the directional antenna 110A by using tilt angle information and installation position information acquired by the acquisition unit 131A. Specifically, the setting unit 132A sets the tilt angle θ based on the positional relationship between the radio base station 100A and the radio base station 100B and on the values of the tilt angles respectively set by the radio base station 100A and the radio base station 100B so as not to cause the directional beams to overlap each other.

Alternatively, the acquisition unit 131A may acquire the terminal altitude value α used for setting the tilt angle of the directional antenna 110B of the radio base station 100B from the radio base station 100B. In this case, the setting unit 132A sets the terminal altitude value α used for setting the tilt angle θ of the directional antenna 110A of the own radio base station differently from the terminal altitude value α of the radio base station 100B. For example, if the directional beam of the directional antenna 110B is directed to the altitude value representing the highest distribution density of the radio terminals 200, the setting unit 132A sets the tilt angle θ so as to direct the directional beam of the directional antenna 110A to an altitude value representing the second highest distribution density of the radio terminals 200.

### (3) Operation and Effect

According to the second embodiment, even if the radio base station 100A and the radio base station 100B are separated in the height direction, it is possible to avoid the interference with each other by setting the tilt angles so as not to cause the directional beams of the radio base station 100A and the radio base station 100B to overlap each other, and thereby to offer an even higher quality communication service to the radio terminals 200.

### (Modification of Second Embodiment)

FIG. 11 is a block diagram showing a configuration of the radio base station 100A according to a modification of the second embodiment. This modification is a mode in which the above-described modification of the first embodiment and the second embodiment are combined.

In the example of FIG. 8 and FIG. 9, the radio base station 100A and the radio base station 100B are installed separately in the height direction. Meanwhile, in this modification, it is possible to install the directional antenna 110A and the directional antenna 110B of the same radio base station 100A separately in the height direction. For example, the directional antenna 110A shown in FIG. 11A is installed on the telephone pole similarly to the FIG. 8 and FIG. 9 while the directional antenna 110B shown in FIG. 11 is installed on the wall face of the building B similarly to FIG. 8 and FIG. 9.

The setting unit of the radio base station 100A sets the respective tilt angles of the directional antenna 110A and the directional antenna 110B so as not to cause the respective directional beams of the directional antenna 110A and the directional antenna 110B to overlap each other.

### Third Embodiment

A third embodiment provides a mode in which a tilt angle is set in an upper network apparatus. In the third embodiment, only different features from those of the first embodiment and the second embodiment will be described and duplicate explanation will be omitted.

FIG. 12 is a schematic configuration diagram of a radio communication system 10C according to the third embodiment. In the radio communication system 10C, the radio base station 100A and the radio base station 100B are each configured as in the second embodiment. However, the radio communication system 10C is different from the second embodiment in that a base station controller 300 is provided for controlling the radio base station 100A and the radio base station 100B. The base station controller 300 is connected to the radio base station 100A and the radio base station 100B via a wired line (a backhaul network). For the base station controller 300 described above, it is possible to use an EMS (Element Management System) in the LTE, for example.

In the third embodiment, the base station controller 300 constitutes an antenna controller device configured to control the directional antenna 110A of the radio base station 100A. The base station controller 300 also controls the directional antenna 110B of the radio base station 100B.

FIG. 13 is a block diagram showing a configuration of the base station controller 300. As shown in FIG. 13, the base station controller 300 includes a control unit 330, a storage unit 340, and a wired line I/F unit 350. The controller 330 includes an acquisition unit 331 and a setting unit 332. The acquisition unit 331 has functions similar to that of the acquisition unit 131A described in the first embodiment and the second embodiment. The setting unit 332 has functions similar to that of the setting unit 132A described in the first embodiment and the second embodiment.

### (5) Other Embodiments

As described above, the details of the present invention have been disclosed by using the embodiments (first embodiment to third embodiment) of the present invention. However, it should not be understood that the description and drawings which constitute part of this disclosure limit the present invention. From this disclosure, various alternative embodiments, examples, and operation techniques will be easily found by those skilled in the art.

In the above-described embodiments, the example is described in which the radio terminal 200 is configured to measure the own position (the longitude, the latitude, and the altitude) and to transmit the positioning data to the base station side. However, other methods are also applicable. For example, it is also possible to apply a scheme in which the radio terminal 200 is configured to transfer a decoded GPS signal to the base station side so that the base station side can return the calculated position information (the positioning data). That is, the entity to calculate the position information (the positioning data) is not limited only to the radio terminal 200.

In the above-described embodiments, the example is described in which the antenna 110A and the antenna 111A are respectively provided with the directionalities toward the different buildings. However, the antenna 110A and the antenna 111A may be used for MIMO (Multiple Input Multiple Output), i.e., for multi-antenna transmission. The LTE employs the MIMO scheme so that multiple antennas can cover the same area and perform data multiplexing and so forth. For example, both of the antenna 110A and the antenna 110B are formed as omniantennas, or namely, are provided with a circular directional pattern around the antenna in a horizontal plane and are provided with a pattern expressed by two oval shapes drawn with broken lines in FIG. 2 and the like when cut along the vertical plane. As described above, in the present invention, the number of antennas constituting the antenna unit is not limited as long as those antennas can change the beam directions in the vertical plane.

In addition to setting the tilt angle θ, the setting unit 132A or the setting unit 332 may also set a beam width of the directional beam based on the state of distribution of the terminal altitude values. Specifically, when the radio terminals 200 are spread over a predetermined range or wider in the height direction, the setting unit 132A or the setting unit 332 sets the beam width wider than an initial value. On the other hand, when the radio terminals are concentrated in an area below a predetermined range in the height direction, the setting unit 132A or the setting unit 332 sets the beam width narrower than the initial value. By performing the control as described above, it is possible to offer an even higher quality service to the radio terminals 200.

In the above-described embodiments, the example is described in which the setting unit 132A or the setting unit 332 sets the tilt angle θ by using the horizontal distance d. Instead, it is also possible to set the tilt angle θ by the following method without using the horizontal distance d. When the terminal altitude value α is higher than the base station altitude value β, the setting unit 132A or the setting unit 332 sets the tilt angle θ to a larger angle on the elevation side as a difference between the terminal altitude value α and the base station altitude value β becomes greater. Meanwhile, when the terminal altitude value α is higher than the base station altitude value β, the setting unit 132A or the setting unit 332 sets the tilt angle θ to a smaller angle on the elevation side as a difference between the terminal altitude value α and the base station altitude value β becomes smaller. According to the above-described setting method, it is possible to reduce a processing load as the horizontal distance value d becomes unnecessary, though accuracy of setting the tilt angle θ is reduced.

Alternatively, it is also possible to use the horizontal distance value d for weighting the radio terminals 200. For example, it is conceivable to improve the communication quality of the radio terminals 200 by setting the tilt angle θ so as to direct the directional beam preferentially to the radio terminal 200 having a large horizontal distance d (a long distance).

In the above-described embodiments, the case is described in which the antenna controller device (the controller 130A or the base station controller 300) sets the tilt angle θ based on the state of distribution of the terminal altitude values. However, the processing in Step S103 in FIG. 4 may be omitted when there are not many radio terminals 200 (or when there is just one terminal, for example) communicating with the radio base station 100A.

In the first embodiment and the second embodiment described above, when an upper network apparatus of the radio base station 100A manages the terminal altitude values, the base station altitude value, and the horizontal distance values, the acquisition unit 132A of the radio base station 100A may acquire the terminal altitude values, the base station altitude value, and the horizontal distance values from the network apparatus through the wired line I/F unit 150A.

In the above-described embodiments the example is described in which the radio base station 100A (the directional antenna 110A) is located between the buildings or on the wall face of the building. Instead, it is also possible to install the radio base station 100A (the directional antenna 110A) in a hill zone, for instance.

In the above-described embodiments, the antenna unit is described which can change the tilt angle electrically. Instead, it is also possible to use an antenna unit which can change the tilt angle mechanically.

As described above, the present invention naturally includes various embodiments which are not described herein. Accordingly, the present invention should be determined only by the matters to define the invention in the scope of claims regarded as appropriate based on the description.

Entire contents of Japanese Patent Application Publication No. 2009-77747 (filed on Mar. 26, 2009) are herein incorporated by reference.

### INDUSTRIAL APPLICABILITY

As described above, an antenna controller device, a radio communication system, and an antenna controlling method according to the present invention are capable of appropriately setting a tilt angle and offering a high quality communication service to radio terminals even when a base station antenna is installed at a low-altitude position and the radio terminals are spread over in the vertical direction. Hence the present invention is useful for radio communication such as mobile telecommunication.

1. An antenna controller device configured to control an antenna unit capable of changing a beam direction in a vertical plane, the beam direction being a direction to which a directional beam is directed, the antenna controller device comprising:
an acquisition unit configured to acquire a terminal altitude value indicating an altitude of a radio terminal connected to a radio base station including the antenna unit; and
a setting unit configured to set a tilt angle being an angle formed between the beam direction and a horizontal direction, by use of the terminal altitude value acquired by the acquisition unit.

2. The antenna controller device according to claim 1, wherein the setting unit sets the tilt angle to an angle of an elevation side.

3. The antenna controller device according to claim 1, wherein
when a plurality of radio terminals spread over in a height direction are connected to the radio base station, the acquisition unit acquires the terminal altitude value for each of the plurality of radio terminals, and
the setting unit sets the tilt angle based on a state of distribution of the terminal altitude values acquired respectively for the plurality of radio terminals.

4. The antenna controller device according to claim 3, wherein the setting unit sets a beam width of the directional beam based on the state of distribution in addition to setting the tilt angle.

5. The antenna controller device according to claim 1, wherein
the acquisition unit further acquires a base station altitude value indicating an altitude of either the antenna unit or the radio base station, and
the setting unit sets the tilt angle by further using the base station altitude value acquired by the acquisition unit.

6. The antenna controller device according to claim 5, wherein when the terminal altitude value is greater than the base station altitude value, the setting unit sets the tilt angle to a larger angle on the elevation side as a difference between the terminal altitude value and the base station altitude value becomes greater.

7. The antenna controller device according to claim 1, wherein
the acquisition unit further acquires information on a different antenna unit at an installation position different from the antenna unit, and
the setting unit sets the tilt angle by further using the information on the different antenna unit so that the directional beam of the antenna unit and the directional beam of the different antenna unit do not overlap each other.

8. The antenna controller device according to claim 1, wherein
the acquisition unit further acquires a horizontal distance value indicating a horizontal distance between either the antenna unit or the radio base station and the radio terminal, and
the setting unit sets the tilt angle by further using the horizontal distance value acquired by the acquisition unit.

9. The antenna controller device according to claim 1, wherein when the radio base station receives positioning data indicating a result of position measurement by the radio terminal from the radio terminal, the acquisition unit acquires the terminal altitude value based on the positioning data received by the radio base station.

10. A radio communication system supporting LTE and comprising a first radio base station having a first antenna unit and a second radio base station having a second antenna unit, wherein
the first radio base station comprises a transmitter configured to transmit tilt angle information indicating a tilt angle of the first antenna unit to the second radio base station through an X2 interface, and
the second radio base station comprises a receiver configured to receive the tilt angle information through the X2 interface.

11. A radio communication system supporting LTE and comprising a first radio base station having a first antenna unit and a second radio base station having a second antenna unit, wherein
the first radio base station comprises a transmitter configured to transmit installation position information indicating an installation position of the first antenna unit to the second radio base station through an X2 interface, and
the second radio base station comprises a receiver configured to receive the installation position information through the X2 interface.

12. An antenna control method of controlling an antenna unit capable of changing a beam direction in a vertical plane, the beam direction being a direction to which a directional beam is directed, the antenna control method comprising the steps of:
acquiring a terminal altitude value indicating an altitude of a radio terminal connected to a radio base station including the directional antenna; and
setting a tilt angle being an angle formed between the beam direction and a horizontal direction by use of the terminal altitude value acquired in the acquiring step.
